(19) United States
(12) Patent Application Publication
(10) Pub. No.: US 2022/0090420 A1
(43) Pub. Date: Mar. 24, 2022

(54) Door Handles

(71) Applicant: Canoo Technologies Inc., Torrance, CA (US)

(72) Inventors: Jenna Kadlec, Hermosa Beach, CA (US); Cian Brogan, Redondo Beach, CA (US); Scott Huang, Lakewood, CA (US); Sagar Shrivastava, San Pedro, CA (US)

(21) Appl. No.: 17/448,495

(22) Filed: Sep. 22, 2021

Related U.S. Application Data
(60) Provisional application No. 63/081,788, filed on Sep. 22, 2020.

(51) Int. Cl. E05B 81/76; E05B 79/06; E05B 83/36; E05B 85/16

(52) U.S. Cl. CPC E05B 81/76; E05B 85/16; E05B 83/36; E05B 79/06

(57) ABSTRACT

A flush mounted door handle lever is at least partly received in a recess of a housing secured to a door panel using a reinforcement panel bonded to the door panel, with the recess aligned with holes through the door panel and reinforcement panel. Locator pins on the reinforcement panel register the hole therethrough with the hole through the door panel. Clips on the reinforcement panel enable quick mounting of the housing and door handle lever. The recess leaves an opening at one end of the door handle lever for insertion of at least one finger. A sensor detecting an outward pull on that end of the door handle lever may also function as a bump sensor, with either movement selectively triggering an electromechanical door actuation. Symmetrical housings and reinforcement panels allow mounting of the door handle with either orientation, as on adjacent “suicide” doors.

### CROSS-REFERENCE TO RELATED APPLICATIONS

This application claims priority to U.S. Provisional Patent Application No. 63/081,788 filed Sep. 22, 2020 and entitled DOOR HANDLES. The content of the above-identified patent document(s) is incorporated herein by reference.

### TECHNICAL FIELD

This disclosure relates generally to vehicle door handles. More specifically, this disclosure relates to aesthetically pleasing, flush mounted door handles that allow for push-pull operation.

### BACKGROUND

Automobile vehicles may generally be described in relation to a body or cabin designed to enclose passengers, and the various electrical, mechanical and structural systems, subsystems, and components that allow the vehicle to operate. In traditional automobile design, the body and various functional systems and components are inextricably intertwined. Automobile vehicles in general are comprised of many different structural and functional components. Certain structural components may serve to house certain functional elements essential for vehicle operation, while other components can serve as both functional and aesthetic to the appearance of the vehicle. For example, windows can serve several functions such as allowing light to enter the cabin while blocking wind and debris from entering and/or allowing fresh air into the cabin and function as a part of the vehicle's air conditioning system.

Many vehicle manufacturers tend to follow traditional approaches to vehicle design and function. Door handles thus typically follow conventional designs.

### SUMMARY

A flush mounted door handle lever is at least partly received in a recess of a housing secured to a door panel using a reinforcement panel bonded to the door panel, with the recess aligned with holes through the door panel and reinforcement panel. Locator pins on the reinforcement panel register the hole therethrough with the hole through the door panel. Clips on the reinforcement panel enable quick mounting of the housing and door handle lever. The recess leaves an opening at one end of the door handle lever for insertion of at least one finger. A sensor detecting an outward pull on that end of the door handle lever may also function as a bump sensor, with either movement selectively triggering an electromechanical door actuation. Symmetrical housings and reinforcement panels allow mounting of the door handle with either orientation, as on adjacent “suicide” doors.

A vehicle door handle assembly includes a door handle lever having an elongated body with a first end and a second end and rotatably disposed within a door handle assembly housing, wherein the housing comprises a recessed region receiving at least a portion of the door handle lever and wherein the recess is longer than the body of the door handle lever. A reinforcement panel to which the door handle assembly housing is attached is secured to a door panel in registration with an opening through the door panel. A door actuation sensor is mounted to a portion of the door handle assembly housing. A connector electrically connected to the door actuation sensor is fixedly disposed on the reinforcement panel, the connector configured to electrically connect to an electromechanical door actuator. The door handle assembly housing is secured to the reinforcement panel with the recess in alignment with the opening through the door panel. The door handle lever is mounted within the door handle assembly housing with an outermost surface of the door handle lever flush with an exterior surface of the door panel around the opening through the door panel.

A difference between a length of the recess and a length of the door handle lever preferably allows insertion of at least one finger between the housing and the door handle lever.

The door actuation sensor is configured to detect at least an outward pull on a first end of the door handle lever.

The door actuation sensor may be configured to selectively function as a bump sensor.

The connector may be a pigtail connector.

The reinforcement panel may comprise locator pins for registration with the opening through the door panel.

The reinforcement panel may comprise clips for alignment of the housing.

A first of the clips may be a 4-way locator aligning the housing in two planes.

A second and a third of the clips may align the housing rotationally about the first clip.

The door handle lever may be mounted with a first orientation in a first of two adjacent suicide doors, and a second door handle lever may be mounted with a second orientation opposite the first orientation in a second of the two adjacent suicide doors.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 is a front perspective view of a vehicle within which flush mounted door handles are implemented in accordance with embodiments of the present disclosure;

FIG. 2 is a sectional view of a door handle in accordance with embodiments of the present disclosure;

FIGS. 3A through 3C are various partial views further illustrating the door handle housing, reinforcement panel, and door panel depicted in FIG. 2;

FIG. 4 illustrates, from a view external to the vehicle, two door handles of the type depicted in FIG. 2 mounted with opposite orientations; and

FIG. 5 is a top sectional view of a door handle of the type depicted in FIG. 2.

### DETAILED DESCRIPTION

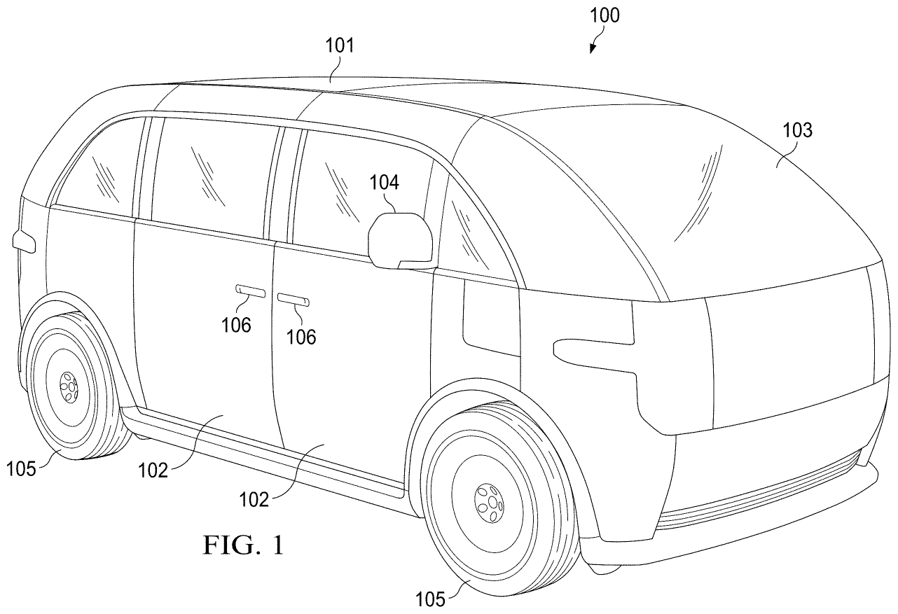

FIGS. 1 through 5, described below, and the various embodiments used to describe the principles of this disclosure are by way of illustration only and should not be construed in any way to limit the scope of this disclosure. Those skilled in the art will understand that the principles of this disclosure may be implemented in any type of suitably arranged device or system.

A door handle is designed for installation on a vehicle door panel such that the door handle sits flush with the exterior surface of the door panel. Additionally, the door handle can be actuated in a number of ways including pulling, rotating, and pushing. The door handle sits within a housing that holds an actuator lever and is connected to an actuator switch that can be connected to the locking or latching mechanism of the door. Actuation of the door lever by pulling can engage or disengage the latching mechanism. Alternatively, the latching mechanism can be actuated by a bump switch located within the housing such that an inward bump to the door handle lever causes the latching mechanism to disengage.

Door handles may be installed or fit such that the outermost surface of the door handle sits flush with the outside face of the door. In traditional door fabrication techniques, a stamped door panel is used. By contrast, in the present disclosure the door panel is fixed with flanges that are in-turned and molded into place. The fixed door panel allows for easier placement and location of the door handle housing, which in turn simplifies placement of a flush mount door handle. The use of flush mount door handles presents challenges such as being operationally slow and/or awkward to use, often requiring additional instructions on use. Additionally, flush mount door handles may have various issues during use, such as freezing in cold temperatures, pinching user's hands, etc. In some areas, manufacturers have increased the complexity of flush mount door handles by adding motors to the door handle that may make the handle self-presenting. Even with self-presenting flush mount door handles, use can be confusing and can present problems with maintenance.

FIG. 1 is a front perspective view of a vehicle within which flush mounted door handles are implemented in accordance with embodiments of the present disclosure. The embodiment shown in FIG. 1 is for illustration and explanation only. FIG. 1 does not limit the scope of this disclosure to any particular vehicle implementation, or exclude variants.

The vehicle 100 of FIG. 1 includes a chassis (not visible in FIG. 1) supporting a cabin 101 for carrying passengers. In some embodiments, the vehicle 100 is an electric vehicle (EV) in which the chassis is in the form of a “skateboard” vehicle platform supporting one or more energy storage elements (e.g., batteries) that provide input electrical power used by various components of the EV, such as one or more electric motors of the vehicle 100 and a control system of the electric vehicle.

Passengers may enter and exit the cabin 101 through at least one door 102 forming part of the cabin 101. A transparent windshield 103 and other transparent panels mounted within and forming part of the cabin 101 allow at least one passenger (referred to as the “operator,” even when the vehicle 100 is operating in an autonomous driving mode) to see outside the cabin 101. Rear view mirrors 104 mounted to sides of the cabin 101 enable the operator to see objects to the sides and rear of the cabin 101 and may include warning indicators (e.g., selectively illuminated warning lights) for features such as blind spot warning (indicating that another vehicle is in the operator's blind spot) and/or lane departure warning.

Wheels 105 mounted on axles that are supported by the chassis and driven by the motor(s) (all not visible in FIG. 1) allow the vehicle 100 to move smoothly. The wheels 105 are mounted on the axles in a manner permitting rotation relative to a longitudinal centerline of the vehicle 100 for steering and are also connected to steering controls (not visible). Conventional automobile features such as headlamps, taillights, turn signal indicators, windshield wipers, and bumpers are also depicted. The vehicle 100 may further include cargo storage within or connected to the cabin 101 and mounted on the chassis, with the cargo storage area(s) optionally partitioned by dividers from the passenger area(s) of the cabin 101.

Although FIG. 1 illustrates one example of a vehicle 100, those skilled in the art will recognize that the full structure and operation of a suitable vehicle are not depicted in the drawings or described here. Instead, for simplicity and clarity, only the structure and operation necessary for an understanding the present disclosure is depicted and described. Various changes may be made to the example of FIG. 1, and the improved door handles described in this disclosure may be used with any other suitable vehicle.

The exemplary embodiment includes flush mounted door handles 106 on the doors 102. In the example shown, the vehicle 100 includes a flush mounted door handle 106 each passenger door 102. The vehicle 100 is shown with a “suicide” door configuration, where the front and rear doors are hinged at opposite sides relative to front and rear ends of the vehicle 100 rather than on the same side.

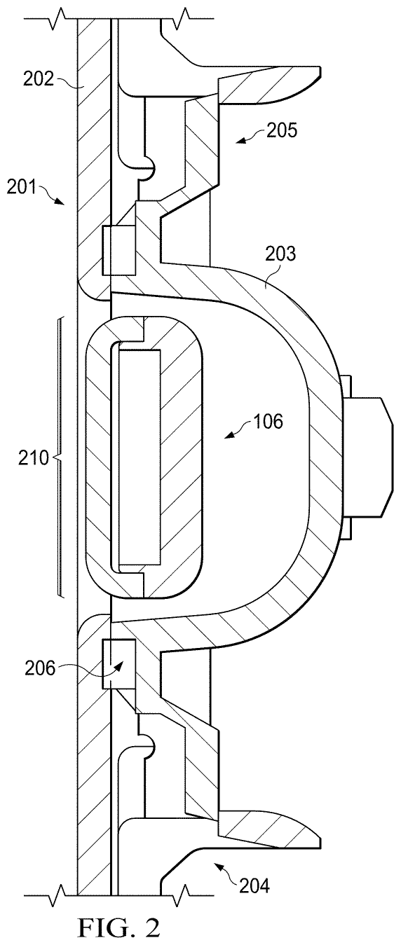

FIG. 2 is a sectional view of a door handle in accordance with embodiments of the present disclosure. The embodiment shown in FIG. 2 is for illustration and explanation only. FIG. 2 does not limit the scope of this disclosure to any particular implementation, or exclude variants.

The door handle 106 is mounted to have an exterior surface substantially flush with, or slightly recessed with respect to, an exterior surface 201 of a door panel 202. A housing 203 for the door handle is mounted inside the door panel 202, aligned with an opening or hole 210 through the door panel 202 and secured to a reinforcement panel 204 that is bonded to the interior of the door panel 202. The reinforcement panel 204 helps to remove or reduce stresses to the door panel 202 that might result from daily use of the door handle, by fully restraining the door handle 106 in the in-out direction relative to the door panel 202. The housing 203 may be removably secured to the reinforcement panel 204 by clips 205. The clips 205 keep the housing 203 and the door handle 106 mounted therein retained to the door panel 202 during general assembly and subsequent use, but allow quick and easy removal of the housing 203 and the door handle 106 for replacement or maintenance.

Locator pins 206 on the reinforcement panel 204 are received by corresponding recesses in the interior surface of the door panel 202, where the recessed have pre-determined positioning relative to the hole 210 for a user to touch the door handle 106. The recesses and the hole 210 in the door panel may be formed by a punch process. The locator pins 206 and corresponding recesses allow quick, proper registration (alignment) of the reinforcement panel 204 relative to the hole 210, improving placement repeatability as well as fit within a high tolerance. The locator pins provide 4-way (and/or 2-way) locating for the door handle 106 to constrain the door handle 106 in at least two planes.

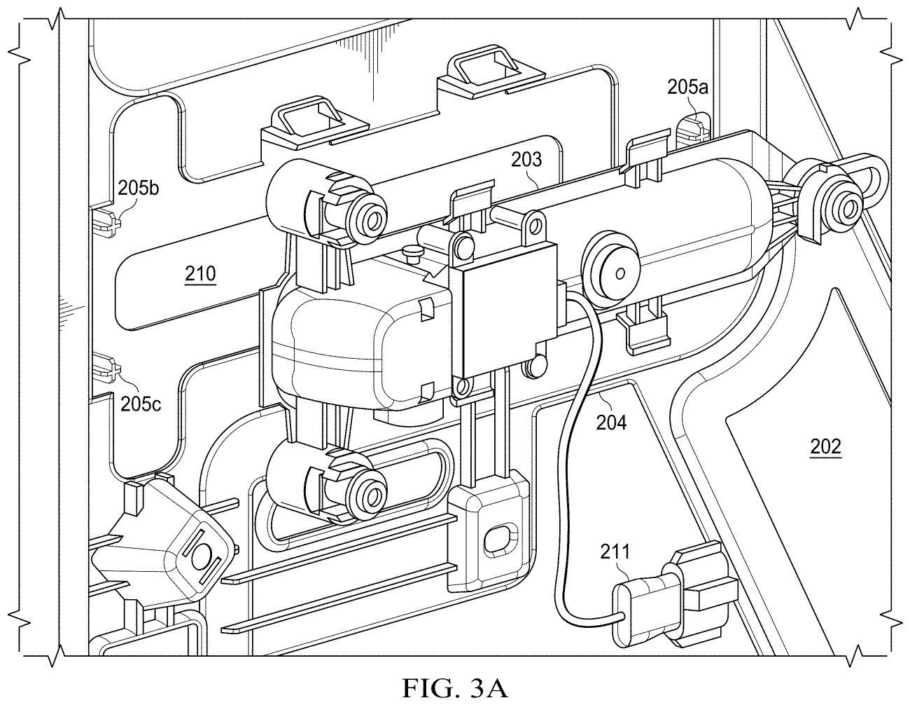

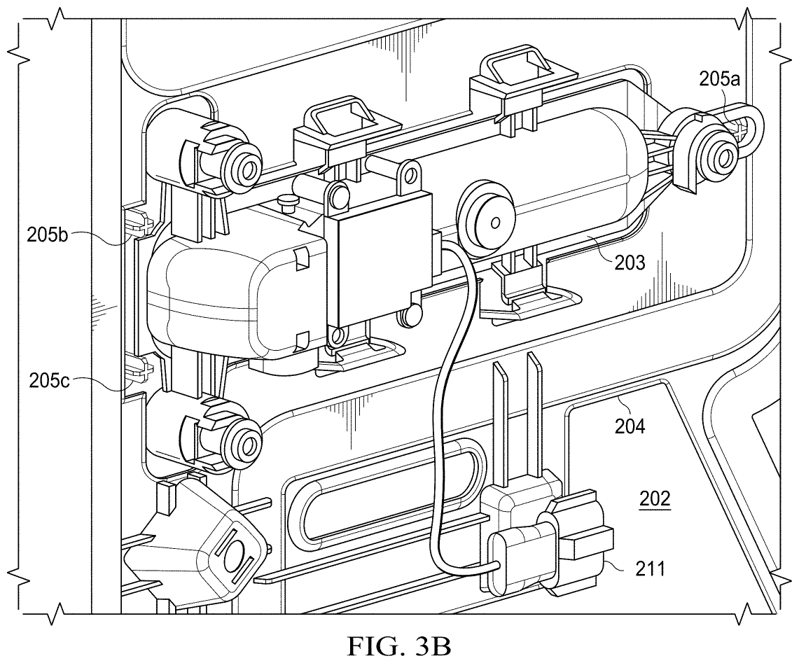

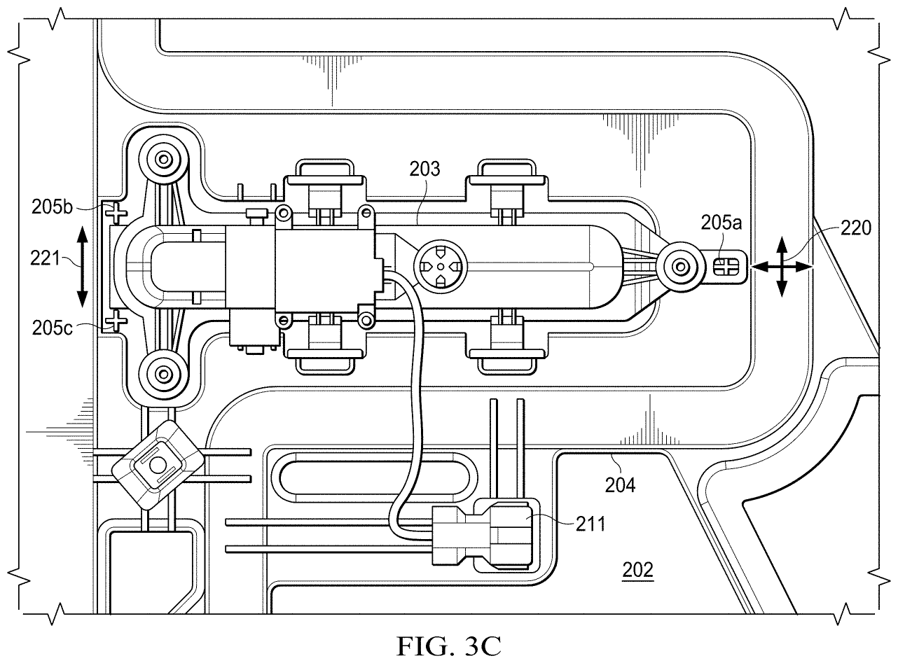

FIGS. 3A through 3C are various partial views further illustrating the door handle housing, reinforcement panel, and door panel depicted in FIG. 2. FIG. 3A is an exploded perspective view, FIG. 3B is an assembled perspective view, and FIG. 3C is an assembled orthogonal view of the door handle housing 203, a portion of the reinforcement panel 204, and a portion of the door panel 202. As depicted by the arrows in FIG. 3C, the clip 205a aligns the housing 203 in two planes relative to the reinforcement panel 204, while the clips 205b and 205c align the housing 203 in two directions (rotational, around clip 205a).

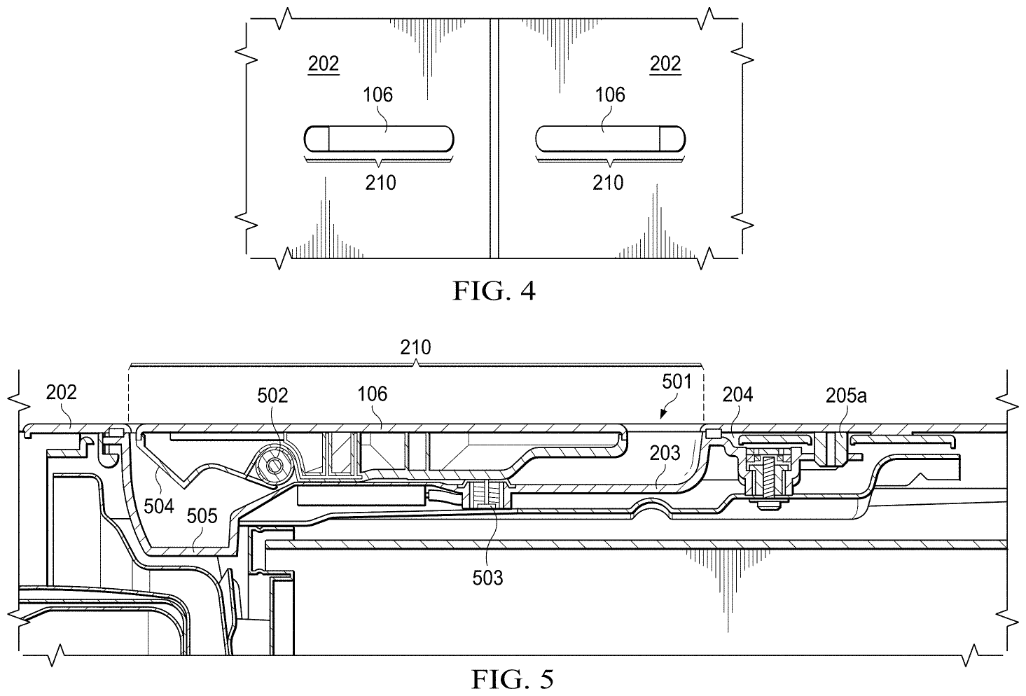

FIG. 4 illustrates, from a view external to the vehicle, two door handles of the type depicted in FIG. 2 mounted with opposite orientations. By simply fabricating mirrored versions of the housing 203 and reinforcement panel 204, keeping all attachment points and handle mechanics symmetrical and keeping the door handle draw direction and axis normal to the body curvature, the same structure for door handle 106 can be used in all door configurations, including the suicide doors depicted in FIG. 1. Additionally, a sensor can be positioned in any door because a flexible pigtail electrical connector 211 that can be positioned anywhere within the door is employed. Clips 205a-205c designed to hold the housing 203 and the associated pigtail electrical connector 211 in a desired position, preventing unwanted movement during vehicle travel, are formed as part of the reinforcement panel 204. Use of the flexible pigtail electrical connector 211 differs from traditional electrical connection models that integrate both the sensor and the connector, thereby requiring different configurations for different door panel placements. Furthermore, a flexible pigtail electrical connector 211 can be helpful in door configurations with unique glass drop, and are further optimal for assembly if the components are assembled from the reinforcement panel inwards, rather than inserted from the inside of the door.

FIG. 5 is a top sectional view of a door handle of the type depicted in FIG. 2. The length of the door handle 106 is less than a corresponding dimension of the opening 210 through the door panel 202 and the recessed portion of the housing 203. That difference in dimension leaves a small opening 501 at one end of the door handle 106, into which one (or more) fingers may be inserted to pull on that end of the door handle 106, causing the door handle to rotate about a pivot pin 502 and initiate opening of the door based on movement of the door handle 106 away from a sensor 503 electrically connected to an electromechanical door opening mechanism. Sensor 503 may also function as a bump sensor, such that bumping, pushing in on, or otherwise applying sufficient pressure to the door handle 106 can cause actuation of the (electromechanical) door opening mechanism. For safety purposes, actuation of the door opening mechanism based on the bump sensor signal may be disabled during movement of the vehicle, and possibly also anytime that the motor is running. The structure of the door handle 106 also includes a stop 504 to limit rotation of the door handle 106 by contact with a corresponding surface 505 of the housing 203. As apparent, the door handle 106 may be biased (e.g., by a torsion spring or other resilient member) toward rotation to the position depicted in FIG. 5.

The present disclosure remedies many of the potential problems associated with flush mounted door handles. A door handle and door handle assembly that is configured to be installed on a vehicle door panel such that the door handle or lever sits flush with the exterior of the vehicle door panel. Many embodiments allow for the actuation of the door handle to occur in a number of ways that are both easy and user friendly to improve the overall function of the door handle and opening of the doors. The flush mount door handles of the present disclosure mount flush with an exterior door panel that is a hang-on panel rather than the traditional stamped door panel and/or formed door panel that is secured with folded edges, and is easy and safe to use. The adaptations described herein make it possible for vehicles incorporate the flush mount door handles for use in areas such as ride sharing, where many passengers and/or first time users will interact with the door handle. The door handles of the present disclosure improve customer satisfaction and ease of use by offering simplified, low cost, and convenient flush mount door handle structure and operation.

As discussed above, ease and safety of door handle use are important design factors to consider. The present disclosure is directed to door handles with intuitive, user friendly, and aesthetically pleasing designs. Because the flush mount door handle has a housing that surrounds the lever portion of the handle, and is longer than the lever itself, an opening is left at one end of the handle for easily grasping the lever portion of the handle to open the door, rather than having to push in on one end of the handle or the other in order to force the handle to an open position. The small opening also allows for the door handle to be engaged with a single finger in the event that only a finger is available for opening the door. The door handles of the present disclosure are designed to comply with standard vehicle regulations and prevent the accidental actuation of the handle in the event of a vehicle crash. Therefore, the door handle design of the present disclosure allows for movement of one portion of the door handle to the exterior and the other toward the interior of the vehicle. Embodiments of the present disclosure may incorporate a bump switch within the door assembly, positioned within the assembly and out of view of the user and configured to actuate the door opening by simply bumping a portion of the door handle lever rather than pulling the lever out. Accordingly, the door handle lever may be hinged within the door handle assembly to rotate in multiple directions, to allow for both a pulling and pushing motion to activate opening of the door.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in this patent document should not be read as implying that any particular element, step, or function is an essential or critical element that must be included in the claim scope. Also, none of the claims is intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A vehicle door handle assembly, comprising:
a door handle lever having an elongated body with a first end and a second end and rotatably disposed within a door handle assembly housing, wherein the housing comprises a recessed region receiving at least a portion of the door handle lever and wherein the recess is longer than the body of the door handle lever;
a reinforcement panel to which the door handle assembly housing is attached, the reinforcement panel secured to a door panel in registration with an opening through the door panel;
a door actuation sensor mounted to a portion of the door handle assembly housing; and
a connector electrically connected to the door actuation sensor and fixedly disposed on the reinforcement panel, the connector configured to electrically connect to an electromechanical door actuator,
wherein the door handle assembly housing is secured to the reinforcement panel with the recess in alignment with the opening through the door panel, and
wherein the door handle lever is mounted within the door handle assembly housing with an outermost surface of the door handle lever flush with an exterior surface of the door panel around the opening through the door panel.

2. The vehicle door handle assembly of claim 1, wherein a difference between a length of the recess and a length of the door handle lever allows insertion of at least one finger between the housing and the door handle lever.

3. The vehicle door handle assembly of claim 1, wherein the door actuation sensor is configured to detect an outward pull on a first end of the door handle lever.

4. The vehicle door handle assembly of claim 3, wherein the door actuation sensor is configured to selectively function as a bump sensor.

5. The vehicle door handle assembly of claim 1, wherein the connector is a pigtail connector.

6. The vehicle door handle assembly of claim 1, wherein the reinforcement panel comprises locator pins for registration with the opening through the door panel.

7. The vehicle door handle assembly of claim 1, wherein the reinforcement panel comprises clips for alignment of the housing.

8. The vehicle door handle assembly of claim 7, wherein a first of the clips is a 4-way locator aligning the housing in two planes.

9. The vehicle door handle assembly of claim 8, wherein a second and a third of the clips align the housing rotationally about the first clip.

10. The vehicle door handle assembly of claim 1, wherein the door handle lever comprises a first door handle lever mounted with a first orientation in a first of two adjacent suicide doors, the vehicle door handle assembly further comprising a second door handle lever mounted with a second orientation opposite the first orientation in a second of the two adjacent suicide doors.

11. A method, comprising:
disposing a door handle lever having an elongated body with a first end and a second end rotatably within a door handle assembly housing, wherein the housing comprises a recessed region receiving at least a portion of the door handle lever and wherein the recess is longer than the body of the door handle lever;
attaching the door handle assembly housing to a reinforcement panel, the reinforcement panel secured to a door panel in registration with an opening through the door panel;
mounting a door actuation sensor to a portion of the door handle assembly housing; and
electrically connecting a connector to the door actuation sensor, the connector fixedly disposed on the reinforcement panel and configured to electrically connect to an electromechanical door actuator,
wherein the door handle assembly housing is secured to the reinforcement panel with the recess in alignment with the opening through the door panel, and
wherein the door handle lever is mounted within the door handle assembly housing with an outermost surface of the door handle lever flush with an exterior surface of the door panel around the opening through the door panel.

12. The method of claim 11, wherein a difference between a length of the recess and a length of the door handle lever allows insertion of at least one finger between the housing and the door handle lever.

13. The method of claim 11, wherein the door actuation sensor is configured to detect an outward pull on a first end of the door handle lever.

14. The method of claim 13, wherein the door actuation sensor is configured to selectively function as a bump sensor.

15. The method of claim 11, wherein the connector is a pigtail connector.

16. The method of claim 11, wherein the reinforcement panel comprises locator pins for registration with the opening through the door panel.

17. The method of claim 11, wherein the reinforcement panel comprises clips for alignment of the housing.

18. The method of claim 17, wherein a first of the clips is a 4-way locator aligning the housing in two planes.

19. The method of claim 18, wherein a second and a third of the clips align the housing rotationally about the first clip.

20. The method of claim 11, wherein the door handle lever comprises a first door handle lever mounted with a first orientation in a first of two adjacent suicide doors, the vehicle door handle assembly further comprising a second door handle lever mounted with a second orientation opposite the first orientation in a second of the two adjacent suicide doors.
